(19) United States
(12) Patent Application Publication
(10) Pub. No.: US 2017/0181226 A1
(43) Pub. Date: Jun. 22, 2017

(54) HEATING DEVICE WITH A SUPPORT AND METHOD FOR THE PRODUCTION THEREOF

(71) Applicant: E.G.O. Elektro-Geraetebau GmbH, Oberderdingen (DE)

(72) Inventors: Roland Muehlnikel, Bretten (DE); Volker Block, Bretten (DE); Holger Koebrich, Kraichtal-Gochsheim (DE); Manuel Schmieder, Oberderdingen (DE); Bernd Robin, Kraichtal (DE); Matthias Mandl, Bretten (DE); Alfred Suss, Bretten (DE); Michael Tafferner, Malsch (DE); Sebastian Eigl, Bretten (DE)

(21) Appl. No.: 15/381,763

(22) Filed: Dec. 16, 2016

(30) Foreign Application Priority Data
Dec. 18, 2015 (DE) 10 2015 226 053.4

(51) Int. Cl. H05B 3/14; H05B 3/20

(52) U.S. Cl. CPC H05B 3/145; H05B 3/20; H05B 2203/013; H05B 2203/017

(57) ABSTRACT

A heating device has a support and a sheet-like electrical conductor, which is arranged on the support and runs between a first terminal and a second terminal, the at least one heating conductor including carbon-based material as heating conductor material. A heating conductor thickness between the electrical terminals may at least partially vary and not be constant for the adaptation of a local heating output. In addition, the heating conductor may be either rectangular and short or in the form of a circular ring.

### CROSS-REFERENCE TO RELATED APPLICATIONS

This application claims priority to German Application No. 10 2015 226 053.4, filed Dec. 18, 2015, the contents of which are hereby incorporated herein in its entirety by reference.

### BACKGROUND

The invention relates to a heating device with a support and with at least one sheet-like electrical heating conductor arranged on the support and also to a method for producing such a heating device.

Such heating devices are variously known, in particular also with so-called thick-film heating conductors.

### BRIEF SUMMARY

The invention addresses the problem of providing a heating device mentioned at the beginning and a method for the production thereof by which problems of the prior art can be solved and by which it is possible in particular to adapt a heating device appropriately to specific uses and exactly prescribed installation or operating conditions.

This problem is solved by a heating device and by a method. Advantageous and preferred configurations of the invention are the subject of the further claims and are explained in more detail below. Some of the features here are only described for the heating device or only for a method for the production thereof. However, irrespective of this, they are intended to be independently applicable both to the heating device and to a production method. The wording of the claims is made the content of the description by express reference.

It is provided that the heating device comprises a support and at least one sheet-like electrical heating conductor, which is arranged on the support, advantageously in a layered structure or as a layer or film, in particular as a thick film. The heating conductor in this case runs between a first electrical terminal and a second electrical terminal. The at least one heating conductor comprises carbon-based material as heating conductor material, for example in a simple configuration a very high proportion of graphite.

In one basic possible configuration of the invention it may be provided that, in the course of a shortest path between the first terminal and the second terminal, this shortest path runs through the heating conductor or through the heating conductor material. This shortest path is advantageously a straight line or a portion of a circle, in particular an exact straight line or an exact portion of a circle. This shortest path runs through the heating conductor and no surface interruption of the heating conductor or incision into the heating conductor is provided in this shortest path. The heating conductor preferably has a geometrical basic form as a rectangle, trapezium or circle or portion of a circular ring.

This definition can achieve the effect that a substantially sheet-like heating conductor can be provided, a number of such heating conductors being well able to cover a sheet-like support. Under some circumstances, just one such sheet-like heating conductor may already be sufficient to heat a single support over its surface area, so that a support only has a single heating conductor.

According to an advantageous basic concept of the invention, which can be combined with the aforementioned basic configuration but can also stand on its own, a heating conductor thickness at least partially varies between the electrical terminals and is consequently not the same or constant throughout. This heating conductor thickness advantageously varies by a factor of 0.01 to 20; the greatest heating conductor thickness may therefore be 1% to 2000% above the smallest heating conductor thickness. The heating conductor thickness is advantageously measured here in a region where the heating conductor only runs over the support, and does not for example overlap one of the terminals for making electrical contact. In absolute terms, the heating conductor thickness may be approximately 20 μm to 70 μm, that is to say lie above the heating conductor thickness of a heating conductor material comprising noble metal by a factor of 3 to 5.

In a first configuration of the invention, the heating conductor may be formed in plan view or in a developed projection in a rectangular manner. In particular, the length of the heating conductor between the first terminal and the second terminal may correspond to 10% to 250% of the width of the heating conductor in the transverse direction in relation to this length, advantageously 50% to 200%. The heating conductor is therefore not so much an elongated path, but more a rather short path with a rather compressed form. It is consequently possible that a support, in particular also a rectangular or approximately rectangular support, is covered by only a single rectangular heating conductor and is covered to between 30% and 95%, preferably between 50% and 70%, by this single heating conductor.

In the case of the invention, with such a rectangular heating conductor a reduction or increase in the heating conductor thickness may be provided in a middle region. As a result, an increased or reduced heating output in certain regions can be brought about here in a way corresponding to the variation in the heating conductor thickness. It is consequently possible indeed in adaptation to the desired function mentioned at the beginning of a local adaptation of the heating output, to achieve this also in the case of a sheet-like heating conductor or in a surface area completely covered over by a heating conductor. The extent of such a region with a reduction or an increase in the heating conductor thickness may be relatively small and for example correspond to 1% to 20% of a length and/or width of the heating conductor. It may however also be greater. Furthermore, it is possible to provide a number of such regions with varied heating conductor thickness, to be precise distributed or separated from one another.

Furthermore, it is possible to provide a region with a varied heating conductor thickness close to an edge or directly at an edge of the heating conductor. Thus, different surface-area heating outputs, or ultimately different temperatures, can be brought about here too.

Quite generally, a reduction or an increase in the heating conductor thickness may advantageously be uniform or strictly monotonically continuous. This means that steps or a step-like or jump-like change in the heating conductor thickness should be avoided advantageous at least in the case of a rectangular heating conductor. This is so because that then brings about locally greatly different current densities and temperature distributions.

Different temperature distributions with respect to a surface area of the support may be desired, for example when heating up media flowing past on the support, such as water or the like. As a result, an optimum temperature transition can indeed then be achieved along the water flow on the support, so that the water flowing past is heated up as well as possible.

In a second configuration of the invention, the at least one heating conductor may be formed in plan view or in a developed projection as a portion of a circular ring or as a complete circular ring. It is in that case advantageously not just somehow arcuate, but runs along a geometrical circle. Particularly advantageously, the inner arcuation and outer arcuation are formed here as circular rings or run along circular rings. While both the aforementioned rectangular form and also here the form of a portion of a circular ring are easily imaginable for flat supports, for curved supports, in particular also support tubes, this is intended to be such that the rectangular form or the circular form is obtained in the developed representation or developed projection, that is to say in the developed form of a support tube which, when viewed, is then indeed a flat sheet-like piece. In a further form of the invention, a freely and differingly or nonuniformly curved support may also be provided, to which the material for the heating conductor is applied by a suitable application process.

In the case of a heating conductor as a circular ring or portion of a circular ring, in a first configuration it may be provided that the first terminal and the second terminal have a substantially radial extent with respect to the circular form of the heating conductor. The at least one heating conductor between the terminals then runs indeed in the circumferential direction from one terminal to the other. This also applies to the current flow, which advantageously also runs substantially, particularly preferably exactly, in the circumferential direction. In this case, a width of the heating conductor in the path between the terminals may remain the same. At least along the circumferential direction, that is to say along the arc that the heating conductor in the form of a portion of a circular ring covers, a heating conductor thickness may also remain substantially the same, but it could also vary slightly by 1% to 20%. Correspondingly, the heating conductor thickness may also advantageously remain substantially the same or be constant along a current flow between the terminals. In a radial direction, the heating conductor thickness may advantageously vary, in particular increase from the inside to the outside in the radial direction. In this case, the heating conductor thickness may increase linearly from the inside to the outside in the radial direction.

As applies generally to the invention as a whole, here a form of the heating conductor thickness may on the one hand be such that the generation of a heating output, and consequently also the temperature distribution on the heating conductor or on the heating device, is the same throughout. Alternatively, higher temperatures may be brought about by higher heating outputs in an inner region or middle region or in an outer region or edge region, as can lower temperatures. For this purpose, the heating conductor thickness may be varied correspondingly, that is to say either reduced or increased.

In a second configuration of the invention, it is possible that the first terminal and the second terminal run substantially in the circumferential direction, one terminal running on the inside and one terminal running on the outside. In this case, the terminals are advantageously concentric in relation to one another. A current flow between the two terminals then runs in the radial direction. The heating conductor is advantageously formed such that a current runs from one terminal to the other exclusively in the radial direction. The terminals and also the heating conductor may be circular rings running all the way around, but this is not compulsory.

In the case of this configuration of the invention, the heating conductor thickness may vary along the current flow or current path between the two terminals. The heating conductor thickness should therefore vary in the radial direction, either increase monotonically or decrease monotonically. This variation should advantageously proceed such that, once again, the generated surface-area output or temperature is largely the same, in particular is the same throughout. Particularly advantageously, the heating conductor thickness decreases from the inside to the outside, in order to bring about a heating output, and consequently temperature generation, that remains approximately the same.

It generally applies in principle that a variation of the heating conductor thickness may also take place in jumps or in steps. The reason for this is for example that the heating conductor is produced on the support in a multi-stage layered structure, in order in this way to reduce the different heating conductor thicknesses. In this case, a layer of heating conductor material is applied to the previous layer and, wherever an increased heating conductor thickness is desired, more layers are simply applied in certain regions. Various application processes may be used for such a method according to the invention, for example printing, in particular screen printing, spraying, inkjet or spin coating processes. Combinations of these are generally also possible. After each application of a layer, a drying of the heating conductor material may take place, possibly even a curing or baking. Because of the resultant great expenditure, usually only one drying operation is performed. Baking or the like for completion only takes place once, right at the end after the heating conductor has been completed. It is in this case possible in principle that the layers respectively differ in thickness, though they are advantageously each of the same thickness.

Especially in the case of processes such as printing or screen printing and inkjet processes, the described application of the individual layers of the heating conductor by a surface-area application process means that it is scarcely avoidable that the heating conductor thickness indeed increases in the manner of jumps or in steps. In the case of processes such as spraying or spin coating, a uniform increase in the heating layer thickness is more likely to be possible.

In one form of the invention, a variation in the heating conductor thickness may take place strictly monotonically, so that there are neither jumps nor other abrupt changes in the heating layer thickness. Such a variation is indeed advantageously uniform. As a result, as mentioned at the beginning, locally distinctly different current flows, and consequently also temperature distributions, can be avoided. For this purpose, it is possible that, according to another method according to the invention, heating conductor material of a finished heating conductor is removed or taken away in certain regions. Thus, a heating conductor thickness that differs or can be influenced can be achieved.

Such a taking-away process may be a grinding-away, scraping-away, sand-blasting or blasting-away process or a laser process or laser-blasting process. Combinations of these are generally possible. The material of the heating conductor may be applied in a number of layers by a process described above in a multi-stage layered structure. More layers are then simply applied in regions of increased heating layer thickness than in regions with a reduced heating layer thickness. By taking away heating conductor material in the way described, locally different heating conductor thicknesses can be achieved. Especially a grinding-away or blasting-away process is indeed suitable for this, in particular for a process for a large surface area. Such a removal of heating conductor material may by all means be distributed over a surface area and either differ from region to region or else be uniform. For example, the aforementioned different heating conductor thicknesses may not be achieved in the building-up process, but only in a taking-away process. This possibly has the advantage over an application process that variations of the heating conductor thickness that are made more uniform and free from jumps or steps can be achieved considerably more easily. Furthermore, it is possible with the method according to the invention to perform an adjustment of the heating conductor to an exact resistance value, so that it generates an exactly defined output. By taking away or removing the heating conductor material in such a way, the generation of surface-area output is affected much less.

In a further configuration of the invention, it is possible that a width of the heating conductor at least partially varies between the two electrical terminals, advantageously by 5% to 20%. Also as a result, in principle a distribution of the heating output, and consequently a distribution of the temperature, with respect to the heating conductor can also be achieved, though only on the scale of a very large area or actually only with respect to the entire width of the heating conductor. To this extent, this measure of the variation of the heating conductor is less well suited for the variations in the heating conductor thickness mentioned at the beginning, which tend to be over a small area.

Various materials may be used as carbon-based heating conductor material, in particular along with the initially mentioned graphite also carbon nanotubes, fullerenes, amorphous carbon or graphene. Further possible carbon-based materials for the heating conductor material are carbon fibre, vitreous carbon, carbon black, aerographite and non-graphitic carbon. Graphite, carbon nanotubes and fullerenes are especially regarded as relatively promising.

In an advantageous further configuration of the invention, the heating conductor material is free from noble metal or does not comprise any expensive noble metal. Apart from cost savings that are possible as a result, a further great advantage can be realized, that is that such a heating conductor of this carbon-based heating conductor material can be produced at significantly lower temperatures than is usually the case. Usually, the heating conductor material for such heating conductors, also from the prior art with noble metal, is applied in the form of a paste, it being possible, depending on the type of application, for this paste sometimes to be of high viscosity, sometimes of low viscosity. A sol-gel paste or a sol-gel system that contains the resistance material, that is to say for example the graphite, and is suitable for the respective application process may be used here. The paste or the system should contain at least as much carbon that, after processing as a heating conductor by drying and baking, the conductor then consists of carbon to at least 50%, advantageously even more, for example 80% to 90%. Consequently, a high electrical conductivity is achieved as a sheet resistance. The sheet resistance of the heating conductor material may be between 20 Ω/□ and 400 Ω/□, preferably 30 Ω/□ to 250 Ω/□. Such heating conductor materials and sol-gel pastes or sol-gel systems are generally known. The surface resistance of a heating conductor material that contains noble metal usually lies in the range of below 1 Ω/□, and therefore is considerably lower.

A further advantage is that the temperatures for baking the conductor material are much lower than for heating conductor material with noble metal. For heating conductor material with noble metal, they are approximately 800° C., for the carbon-based heating conductor material used here they are approximately 400° C. This on the one hand makes a great saving of energy possible, because, as known, the baking takes a long time, generally in the range of one hour. On the other hand, the thermal loading, and ultimately also mechanical loading, of the heating device, in particular of the support, is lower. Consequently, simpler insulating layers can possibly be used, or other materials with lower temperature-resistance requirements.

When applying the heating conductor material by spraying, inkjet or spin coating, masks, stencils or the like may be used.

In a further possible configuration of the invention, the heating conductor as a whole may have a negative temperature coefficient of its resistance, in particular because of the proportion of graphite. Then the electrical resistance falls with the temperature, and consequently the power converted therein increases.

These and other features emerge not only from the claims but also from the description and the drawings, where the individual features can be realized in each case by themselves or as a plurality in the form of subcombinations in an embodiment of the invention and in other fields and can constitute advantageous and inherently protectable embodiments for which protection is claimed here. The subdivision of the application into subheadings and individual sections does not restrict the general validity of the statements made thereunder.

### BRIEF DESCRIPTION OF THE SEVERAL VIEWS OF THE DRAWINGS

Exemplary embodiments of the invention are illustrated schematically in the drawings and explained in greater detail below. In the drawings:

FIG. 1 shows a plan view of a heating device according to the invention with two rectangular heating conductors on it;

FIG. 2 shows an alternative heating device with a square support and eight heating conductors on it;

FIG. 3A shows a plan view of a single heating conductor of a rectangular form with various heating conductor thicknesses and a depicted resistance progression;

FIGS. 3B to 3D show three different profiles of a heating conductor thickness;

FIG. 3E shows a schematized representation of two processes for applying the heating conductor material to a support;

FIG. 3F shows two schematized processes for taking away heating conductor material for a differing progression of the heating conductor thickness;

FIGS. 4 and 5 show a plan view and an oblique view of a heating device according to the invention of a round form with radially differing heating conductor thicknesses and a current flow in the circumferential direction;

FIGS. 6 and 7 show a plan view and an oblique view of a further circular heating conductor with different heating conductor thicknesses in the radial direction and a radial current flow;

FIGS. 8 and 9 show a modification of the heating device from FIGS. 6 and 7 with radially running interruptions in the heating conductor material; and

FIGS. 10 and 11 show a modification of the heating device from FIGS. 4 and 5 with interruptions running in the circumferential direction between heating conductor paths.

### DETAILED DESCRIPTION

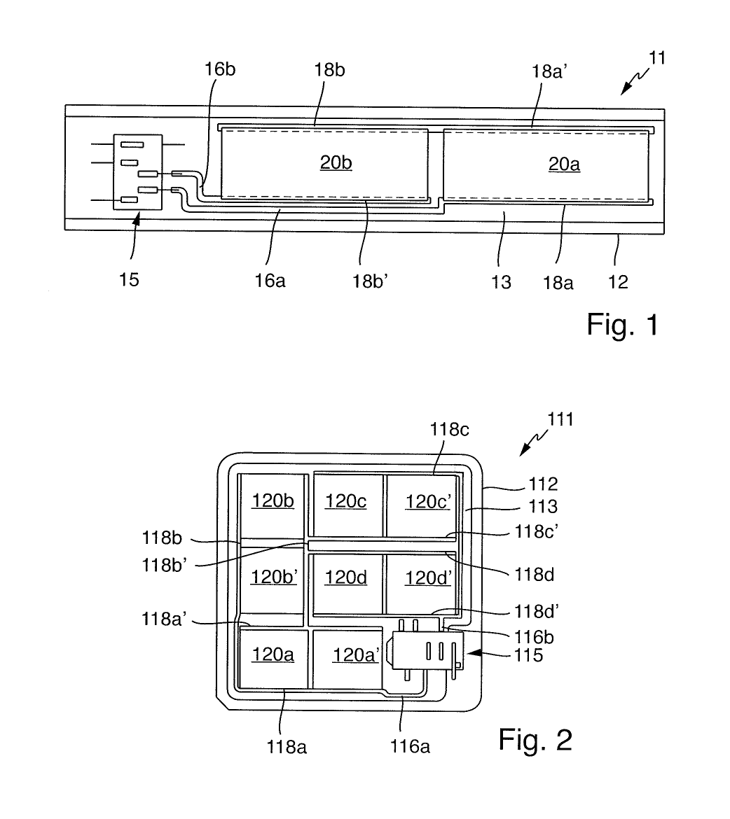

In FIG. 1, a heating device 11 with a flat and elongated rectangular support 12 is shown. This support 12 could also be imagined as a developed projection of a short tube with a round cross section, so that the left-hand end and the right-hand end would be closed and the inner side of the tube, as the inner side of the support 12, would be free. A sheet-like insulating layer 13 has been applied to the support 12. This corresponds to a usual procedure.

Mounted on the support 12 on the left is a connection device 15 in the form of a connector. Extending from this are supply leads 16a and 16b, which lead into terminals 18. These are a lower terminal 18a on the far right and a terminal 18a′ lying opposite, this upper terminal 18a′ going over directly into a further upper terminal 18b. Lying opposite that in the lower region is a terminal 18b′, which then indeed goes over into the supply lead 16b to the connection device 15.

Two heating conductors 20a and 20b are provided, applied in an overlapping way to the terminals 18, as is known for layered heating conductors or thick-film heating conductors. In terms of surface area, the two heating conductors 20a and 20b are of the same size and are formed so as to be substantially the same or identical. As can be seen, their width is approximately four times as great as their length; they are therefore very short. The two heating conductors 20a and 20b are connected in series to one another. The lateral distance between them is very small and is a few mm.

The heating conductors 20 are formed from the heating conductor material according to the invention, which is carbon-based or which in the useable state contains at least 50%, possibly even 80% to 90%, carbon. For example, in a simple case this may be graphite; alternatively or in addition, it may be graphene or carbon nanotubes. A possible negative temperature coefficient of the electrical resistance of the carbon-based material, in particular of graphite, may be used as explained at the beginning to provide that, in potentially cooler regions, the resistance falls with the temperature, or a greater amount of power is converted. At the same time, measures to avoid overheating are then required. Discrete temperature sensors or a sheet-like temperature monitor, which are sufficiently known from the prior art but are not presented here, are advantageously used for this.

In the case of the exemplary embodiment of a heating device 11 that is shown in FIG. 1, a constant or uniform heating conductor thickness is provided. This may for example be 20 μm to 70 μm, that is to say still lie in the range of a thick film. The surface area may be just 40 cm2, so that, with a voltage of 230 V applied to the terminals 18, a power output of approximately 2000 W is generated. This means a sheet resistance of 63 Ω/□ and a connected load per unit area of approximately over 50 W/cm2. More about possible application processes for the heating conductor material is stated below.

Shown in FIG. 2 is a further heating device 111, which likewise has a flat planar support 112, which is formed here in a substantially square manner, but otherwise its structure is the same in many aspects as that in FIG. 1. An insulating layer 113 has been applied to the support 111, together with a connection device 115 with supply leads 116a and 116b. The supply leads 116a and 116b run to terminals 118a and 118a′ and also 118d and 118d′. Respectively provided in between are two parallel heating conductors 120a and 120a′ and also 120d and 120d′. The terminal 118a is connected to a terminal 118b, and the terminal 118a′ is connected to a terminal 118b′. Between the terminals 118b and 118b′ are heating conductors 120b and 120b′. Connected to the terminals 118b′ and 118d′ are terminals 118c′ and 118c, between which there are two heating conductors 120c and 120c′.

All of the heating conductors 120 are formed identically and are substantially square. The pairs of heating conductors 120 respectively connected in parallel and lying directly next to one another may also cover over the narrow gaps separating them, and consequently be a single heating conductor. With this configuration, a series connection of two groups of four heating conductors is achieved, each group of four being connected in a parallel arrangement. This can be seen from the path of the terminals 118. Also in terms of the material and the application process, the heating conductors 120 may also correspond to those of FIG. 1. In a similar form, the support 112 could also be a developed projection of an arcuate or even tube-like support. Here, too, the heating conductor material may largely consist of graphite or comprise graphite.

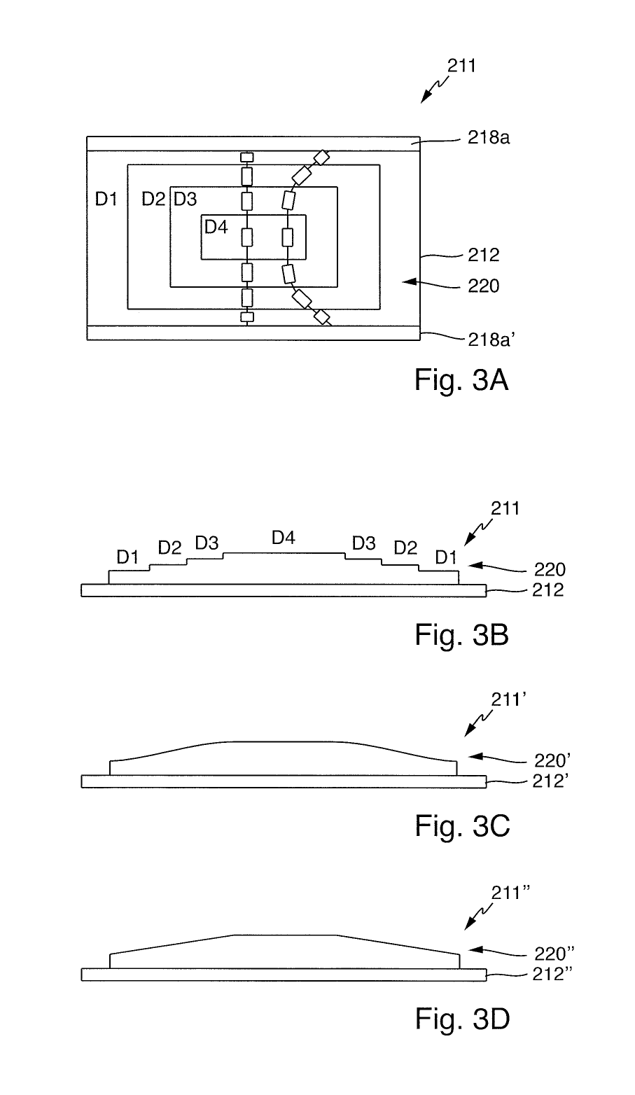

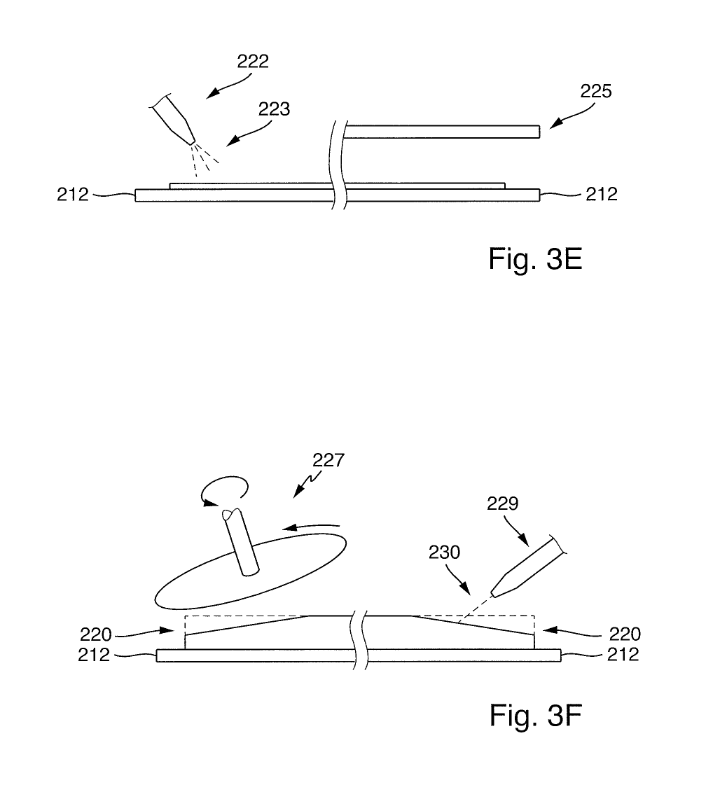

In FIG. 3A, a heating device 211 with a support 212 as a rectangular plate is shown in a very simplified form. Here, this support may be insulating, and therefore does not require an insulating layer. An upper terminal 218a and a lower terminal 218a′, which as in general have been produced from material of very good conductivity, in particular with a high metal content, have been applied to the support 212. Applied on top is a sheet-like heating conductor 220 of a rectangular basic form, which overlaps the terminals 218a and 218a′ for making electrical contact. It is intended to be indicated by the smaller rectangular areas in the middle region that, as the representation from the side of FIG. 3B shows, here the heating conductor thickness increases towards a middle region. For this purpose, with the stepped increase there are four thickness regions D1 to D4. As can be seen from the representation from the side of FIG. 3B, from the thickness region D1, the differences in thickness are considerably smaller than the thickness thereof, for example they lie between 1% and 10%. The representation of FIG. 3B is shown greatly exaggerated here for the sake of clarity. While the thicknesses in the individual thickness regions increase, the respective sheet resistance correspondingly decreases, to be precise to the same degree as the variation in thickness. The individual thickness regions D do not have to correspond in the inner direction to the outer form or the basic form of the heating conductor 220, they may also be approximated in the inner direction to an ellipse. Generally, the configuration of the different thickness regions or of the heating conductor thickness should also be optimized for the respective application with the specific conditions of a heat removal from the heating conductor 220 or from the heating device 211, advantageously into a medium. In particular in edge regions or in middle regions, the basic form and also the heating conductor thickness itself may be optimized by simulation or practical trial and error.

The different heating conductor thicknesses of the thickness regions D1 to D4 make different power densities possible, and consequently an as it were configurable temperature distribution. As a result of the greater thickness in the middle region of the heating conductor 220, here the heating output is somewhat reduced, which is of advantage for a uniform temperature distribution, since the highest temperature usually prevails in a middle region of a sheet-like heating conductor.

In broad approximation, a series connection of component resistors in a way corresponding to that thickness region that is represented in the middle may be imagined for the current flow between the terminals 218a and 218a′. The current flow running here in the middle runs as it were through the seven component resistors, the component resistor in the thickness region D4 having the smallest resistance value on account of the greatest heating conductor thickness. The component resistor in the thickness region D1 is in each case the greatest.

Somewhat to the right thereof, it is shown for a further current flow how, as it were as a result of the in fact same size distribution of the resistance values of the component resistors, here the current flow no longer flows directly from the terminal 218a to the terminal 218a′, that is to say no longer chooses the shortest path, but as it were is bent or curved towards the middle region. The reason for this is that, although the current chooses an altogether somewhat longer path in order to flow through the thickness region D4, it finds a lower resistance there, compensating approximately for the greater length. Consequently, here there is a kind of current diversion.

In FIG. 3B, as stated, the step-like progression of the heating conductor thickness is shown exaggerated for the heating device 211. Such a progression can be produced particularly well by applying the heating conductor material in a number of layers. A difference between two thickness regions D may then be a layer thickness, or the thickness of a single applied layer of heating conductor material. There are actually no reasons for a coarser graduation.

A further heating device 211′ is shown in FIG. 3C, with a support 212′ together with a heating conductor 220′. In a middle region, this support evidently has a similar thickness to the heating device 211, only here there are no exactly distinguishable thickness regions with a stepped or graduated progression. Rather, the thickness increases at first slowly from the thinnest region at the left-hand and right-hand edges, then somewhat more steeply, to then go over again to a more gentle increase in thickness in the planar middle region. Such a progression of the heating conductor thickness may be of advantage for a uniform current flow and a uniform generation of power output, but is evidently more difficult to produce. By using spraying for example as an application process, it is possible here either to work with different spraying intensities and/or with different spraying distances in order to achieve the uniform progression. Alternatively, corresponding taking-away processes may be used, as described at the beginning and further explained in detail below.

In FIG. 3D, a heating device 211″ is shown, with a support 212″ and a heating conductor 220″. Here, the progression of the increase in thickness between the outer thin regions and the thick middle region is as it were linear. Consequently, although a kind of edge is provided at the transition to the middle region, its negative effect is limited. Such a linear progression as it were of the heating conductor thickness can be achieved relatively easily by grinding away with a planar grinding face, as explained below in FIG. 3F.

In FIG. 3E, two possibilities for processes for applying the heating conductor material are schematically represented. In the left-hand region, a sol-gel system 223 is applied to a support 212 by means of a spray nozzle 222 in order to form layers. This sol-gel system contains the carbon-based heating conductor material, which is known per se from the prior art. It must be suitable for spraying. In this case, a number of layers of heating conductor material or of the sol-gel system 223 are applied one after the other, a drying operation taking place either after each layer, after for example every third or fifth layer, or only right at the end. Depending on the accuracy of the work with the spray nozzle 222, a progression of the heating conductor thickness corresponding to FIG. 3C can be produced.

Schematically represented on the right in FIG. 3E is a screen printing process with a printing screen 225. This is placed onto the support 212, as is usual in the case of screen printing, then the heating conductor material is applied as a sol-gel system or here as a possible sol-gel paste to the printing screen 225 and distributed with a doctor blade. By means of a screen printing process, a progression of the heating conductor thickness corresponding to FIG. 3B can be produced, therefore in a rather stepped manner. To achieve a desired heating conductor thickness, a number of layers must in any case be applied. Here, too, an interim drying may be provided.

The application process is followed by a baking. The finished heating conductor contains a high proportion of carbon, for example at least 50% or even 80% to 90%.

It is shown in FIG. 3F how a specific progression of a heating conductor thickness can be achieved by a taking-away process. A very thick heating conductor 220 is represented by dashed lines on a support 212, almost with the thickness remaining the same as it was originally produced. On the left in FIG. 3F, part of the heating conductor material is simply ground away with a rotating planar grinding wheel 227, represented in a very simplified form. Thus, the progression of the heating conductor thickness can be produced in a way corresponding to FIG. 3D. Such a grinding process is regarded as very advantageous for such thickness distributions.

Another taking-away process is represented on the right in FIG. 3F. Here, heating conductor material is taken away from a layer thickness of the heating conductor 220 identified by the dashed lines. Work is performed here with a laser 229, the laser beam 230 of which takes away the heating conductor material as desired. Such laser processes are known and therefore need not be explained any further here.

It applies in principle to the taking-away processes that they can be carried out before a curing of the heating conductor material and thereafter. A grinding process, as represented on the left in FIG. 3F, is advantageously rather carried out after a curing and completion of the heating conductor 220. Before the curing of the paste or of the heating conductor material, it presumably also cannot be ground very well.

A laser process shown on the right in FIG. 3F may be carried out both on a cured heating conductor material and before the curing and after the aforementioned drying. Not yet cured heating conductor material may under some circumstances even be removed more easily.

As mentioned at the beginning, an adjustment of the heating conductor in the electrical sense, that is to say to an exact resistance value, may also be performed by such a taking-away process. For this too, the heating conductor should be cured in the finished state. A surface-area taking-away process according to one aspect of the invention allows the heating function of the heating conductor to be obtained in this region; only under some circumstances is the temperature generated changed somewhat.

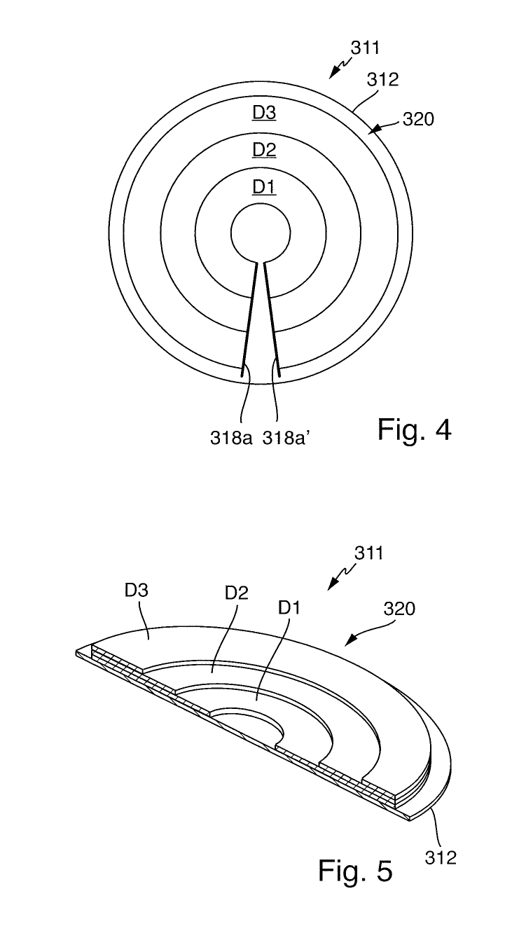

In FIG. 4, a further heating device 311 is shown in plan view and in FIG. 5 in a sectioned oblique view. A heating conductor 320 has been applied to a circular support 312 as a circular ring running around an arc angle of approximately 340°. Two terminals 318a and 318a′, which run exactly radially, are provided. From these terminals 318a and 318a′, the heating conductor 320 runs with three different thickness regions D1, D2 and D3. As can be seen from the sectional representation of FIG. 5, the stepped progression, which is similar in principle to that of FIGS. 3A and 3B, is achieved in each case by different layer thicknesses or numbers of layers. To this extent, what has been said above applies to the production of the heating device 311 and of the heating conductor 320. The considerably greater length of the radial outer region of the heating conductor 320 is compensated by its greater heating conductor thickness in this thickness region D3. Consequently, altogether a heating output per unit area that is approximately the same is generated, since as it were there is in each case the same sheet resistance of the heating conductor material in the circumferential direction between the terminals 318a and 318a′ in the combination of the different length of the heating conductor with the respective heating conductor thickness.

A free middle region of the heating device 311 has the effect here of achieving a somewhat lower temperature. In order to compensate for this, a somewhat higher temperature can be achieved, or a somewhat higher heating output per unit area can be generated, in the thickness region D1. This can be set by the heating conductor thickness in the thickness region D1.

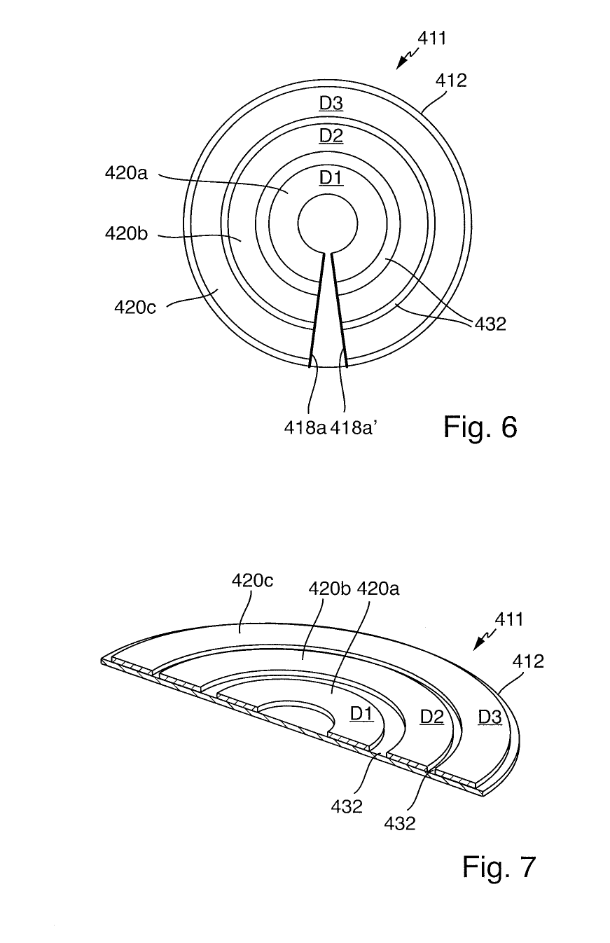

In FIGS. 6 and 7, a further heating device 411 similar to those from FIGS. 4 and 5 is shown, with a round support 312 and two radially running terminals 418a and 418a′. In between there run three heating conductors 420a, 420b and 420c. They are respectively separated from one another by interruptions 432, as is clear from the sectional representation. Furthermore, in a way similar to FIGS. 4 and 5, the heating conductors 420a, 420b and 420c are again intended to be divided into three thickness regions D1, D2 and D3. Unlike in FIG. 5, this is not shown in FIG. 7, but is also intended to be the case here. Consequently, here too the respectively different long path of the current flow between the terminals 418a and 418a′ is compensated by a setting of the heating conductor thickness. Consequently, the same heating output per unit area can be achieved for each of the heating conductors 420a to 420c.

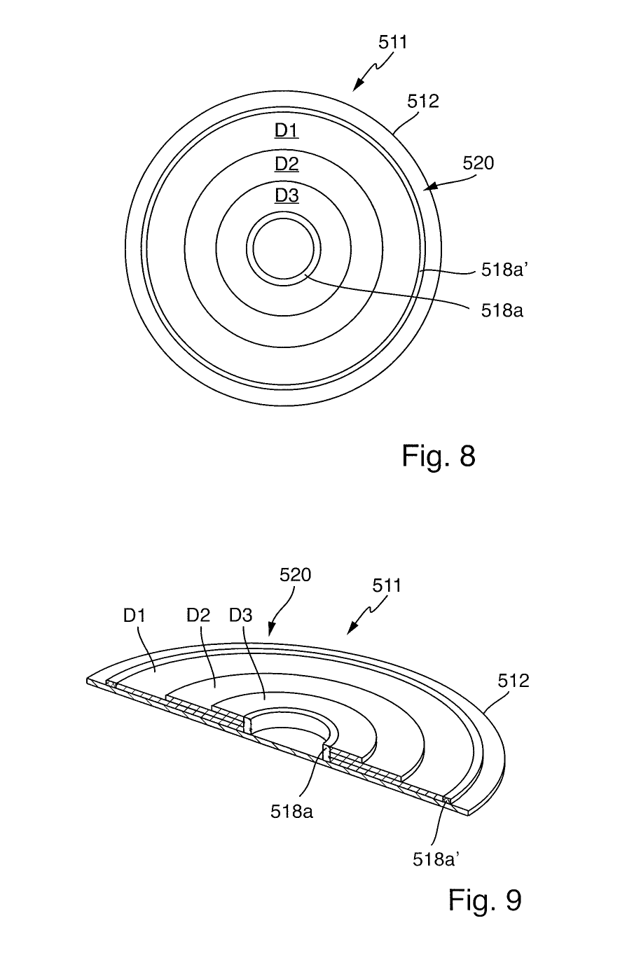

A further configuration of a heating device 511, which is likewise formed in a round manner or as a round support 512, is shown in FIGS. 8 and 9. An inner terminal 518a and an outer terminal 518a′ have been applied to the support 512. As the oblique sectional representation of FIG. 9 shows, especially the inner terminal 518a is not just formed as a purely two-dimensional surface area, but has a certain extent in terms of height. This is intended to serve the purpose of making contact with the thereby contacted heating conductor not only on its lower surface, as a rest on the support 512, but also as it were over its layer thickness on the inner end face.

A heating conductor 520, which is divided into different thickness regions in a way similar to in FIGS. 4 and 5, just with precisely the reverse thickness distribution, has been applied to the support 512 and to the terminals 518a and 518a′. The heating conductor 520 is formed as a circumferentially continuous circular ring and has on the outside a thickness region D1, on the inside a thickness region D3 and in between a thickness region D2. The heating conductor thickness decreases from the inside to the outside, that is to say from the terminal 518a to the terminal 518a′. While in the exemplary embodiments of FIGS. 4 to 7 the current flow proceeds in the circumferential direction, in the exemplary embodiment of FIGS. 8 and 9 it runs in the radial direction. The distribution of the heating conductor thickness, which can be seen from FIG. 9 with a step-like progression, brings about a heating output per unit area that is altogether uniformly distributed over the surface area of the heating device 511 in a way corresponding to an advantageous aspect of the invention. In the thickness region D3 with the greatest heating conductor thickness, the resistance is at the lowest, but on the other hand the current density is very great. In the outer thickness region D1, the electrical resistance is greater as a result of the low heating conductor thickness, but on the other hand the current density is lower on account of the significantly greater circumference. The stepped progression of the thickness regions D1 to D3 represented here may of course also be distributed or compensated in the way explained above on the basis of FIGS. 3B to 3D.

As a result of a radial current flow provided here, the length of the current flow is less than in the case of the heating device of FIGS. 4 and 5, so that, with the same operating voltage and the same overall heating output, the heating conductor thicknesses of the thickness regions D1 to D3 are in any case lower than there.

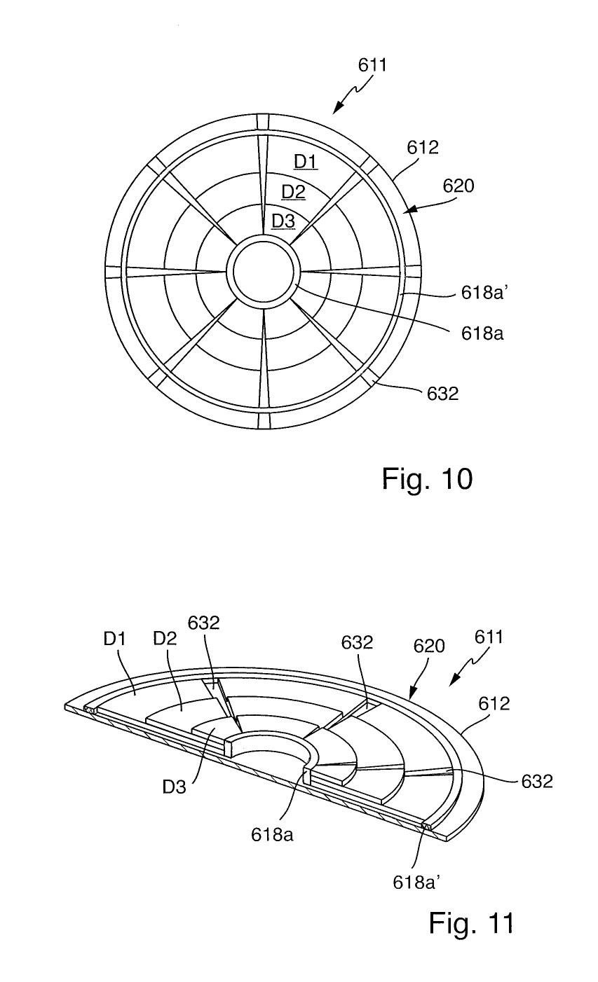

In the exemplary embodiment of a heating device 611 corresponding to FIGS. 10 and 11, as it were a modification of the heating device 511 from FIGS. 8 and 9 is shown; to be precise, eight interruptions 632 are provided here, in a way similar to the interruptions 432 running in the circumferential direction in FIG. 7. These divide a heating conductor 620 by their radial progression into eight portions of a circular ring. Since, however, the current flow always takes place exactly radially between the terminals 618a and 618a′, these interruptions 632 do not disturb the current flow. They only reduce somewhat the overall surface area of the heating conductor 620, and consequently somewhat the overall surface area that is heated directly.

That which is claimed:

1. A heating device comprising:
a support; and
at least one sheet-like electrical heating conductor arranged on said support, said heating conductor running between a first terminal and a second terminal, wherein said heating conductor comprises carbon-based material as heating conductor material.

2. The heating device according to claim 1, wherein, in a course of a shortest path between said first terminal and said second terminal, said shortest path running through said heating conductor, no surface interruption of said heating conductor or incision is provided in said shortest path.

3. The heating device according to claim 1, wherein a thickness of said heating conductor varies at least partially and is not constant between said first and said second terminal.

4. The heating device according to claim 3, wherein said heating conductor thickness varies by a factor of 0.01 to 20.

5. The heating device according to claim 1, wherein in plan view or in a developed projection said heating conductor is rectangular.

6. The heating device according to claim 5, wherein in plan view or in a developed projection, a length of said heating conductor between said first terminal and said second terminal corresponds to 10% to 250% of a width of said heating conductor in a transverse direction in relation to said length.

7. The heating device according to claim 5, wherein said heating conductor has in a middle region a reduction or an increase in a thickness of said heating conductor.

8. The heating device according to claim 7, wherein said heating conductor has in said middle region a uniform or strictly monotonically continuous reduction or a uniform or strictly monotonically continuous increase of said heating conductor thickness.

9. The heating device according to claim 1, wherein said at least one heating conductor is formed in plan view as a portion of a circular ring.

10. The heating device according to claim 9, wherein said first terminal and said second terminal have a substantially radial extent, said at least one heating conductor between said terminals together with a current flow through said heating conductor running in a circumferential direction.

11. The heating device according to claim 10, wherein a thickness of said heating conductor along a shortest path or a current flow between said terminals remains substantially the same or is constant.

12. The heating device according to claim 9, wherein said first terminal and said second terminal run substantially in a circumferential direction, one said terminal running on an inside and one said terminal running on an outside.

13. The heating device according to claim 12, wherein said one terminal runs concentrically in relation to said other terminal, wherein a current flow between said two terminals is running in a radial direction.

14. The heating device according to claim 12, wherein a thickness of said heating conductor varies along a current flow or current path between said two terminals.

15. The heating device according to claim 14, wherein said heating conductor thickness increases monotonically or decreases monotonically along a current flow or current path between said two terminals.

16. The heating device according to claim 1, wherein a variation of a thickness of said heating conductor takes place in jumps or in steps.

17. The heating device according to claim 1, wherein a variation of said heating conductor thickness takes place strictly monotonically.

18. The heating device according to claim 1, wherein a width of said heating conductor at least partially varies between said two electrical terminals.

19. The heating device according to claim 1, wherein said heating conductor is produced by applying layers, said layers in each case being of the same thickness, wherein more layers are applied in regions of increased heating layer thickness than in regions of reduced heating layer thickness.

20. The heating device according to claim 1, wherein different heating conductor thicknesses have been achieved by taking away some of said heating conductor material.

21. The heating device according to claim 20, wherein said different heating conductor thicknesses have been achieved by taking away heating conductor material with a removal distributed over a surface area, said removal differing or being uniform.

22. The heating device according to claim 1, wherein said at least one heating conductor comprises graphite, carbon nanotubes, fullerenes, amorphous carbon or graphene as carbon-based heating conductor material.

23. The heating device according to claim 1, wherein said heating conductor material is free from noble metal.

24. The heating device according to claim 1, wherein a sheet resistance of said heating conductor material is 20 Ω/□ to 400 Ω/□.

25. A method for producing a heating device according to claim 3, wherein said heating conductor is produced on said support in a multi-stage layered structure, with an application of one layer of said heating conductor material on the other for said different or varying heating conductor thicknesses, said application process being selected from one of the following group: printing, spraying, inkjet, spin coating and screen printing processes.

26. A method for producing a heating device according to claim 3, wherein said heating conductor material of said heating conductor after being finished is removed or taken away in certain regions.

27. The method for producing a heating device according to claim 26, wherein heating conductor material of said finished heating conductor is removed or taken away in certain regions by a process from the group: grinding-away, scraping-away, laser-blasting, sand-blasting and blasting-away processes.

28. The method according to claim 26, wherein, for an adjustment of said heating conductor to an exact resistance value, said heating conductor material is taken away or removed in certain regions.

29. The method according to claim 28, wherein said heating conductor material is taken away or removed during a resistance measurement.
